(19) United States
(12) Patent Application Publication
(10) Pub. No.: US 2019/0271452 A1
(43) Pub. Date: Sep. 5, 2019

(54) Outdoor Christmas Lights Pocket

(71) Applicant: Ann Stephens, Los Angele, CA (US)

(72) Inventor: Ann Stephens, Los Angele, CA (US)

(21) Appl. No.: 16/121,592

(22) Filed: Sep. 4, 2018

Related U.S. Application Data
(60) Provisional application No. 62/553,416, filed on Sep. 1, 2017.

(51) Int. Cl. F21V 17/10; F21S 4/20

(52) U.S. Cl. CPC F21V 17/108; F21W 2121/004; F21S 4/20

(57) ABSTRACT

A long cover, having a top edge and a bottom edge, wherein the top edge is mounted to the soffit or fascia boards of the roof of a house or other structure, and the cover hangs down behind a string of lights and can be folded to form a pocket to store the lights when not in use.

### CLAIM OF PRIORITY

This patent application claims priority under 35 USC 119 (e) (1) from U.S. Provisional Patent Application Ser. No. 62/553,416, filed Sep. 1, 2017, of common inventorship and title herewith, which is incorporated herein by reference as though the same were set forth in its entirety.

### FIELD OF THE INVENTION

The present invention pertains to outdoor lights, and more specifically to the field of outdoor Christmas lights, and even more specifically to pockets for storing outdoor Christmas lights which reduce the time and labor spent year after year by homeowners who decorate for Christmas, by stringing lights along the eaves or fascia boards of their houses.

### BACKGROUND OF THE INVENTION

Christianity is the world's largest religion, with approximately 2.1 billion adherents worldwide. For Christian believers, the two pivotal celebrations of the year concern the miraculous birth of Jesus, which is celebrated as Christmas; and the death and resurrection of Jesus, celebrated as Easter. Like all religions, Christianity was influenced by, and incorporated, folk and mythic traditions far older than itself. It is no coincidence, for example, that Christmas is celebrated a few days after the Winter Solstice; nor that Easter, occurring just after the Vernal Equinox, celebrates a spring-like renewal of the soul. The solstices and equinoxes are the turning points in the solar year, and have been celebrated by most of the peoples of the world for thousands, probably tens of thousands, of years. Both Stonehenge, in England, and the Egyptian pyramids, to cite just two examples, are widely believed to have functioned in large part as massive solar calendars.

In ancient times, plants and trees that remained green all year had a special meaning for people in the winter. Just as people today decorate their homes during the Christmas season with pine, spruce, and fir trees, ancient peoples hung evergreen boughs over their doors and windows. In the 16th century, German Protestant Christians began the modern tradition of the decorated, indoor, evergreen Christmas tree, which eventually spread to the rest of Europe, and, by the mid-19th century, to the United States. To many people today, Christian or not, Christmas is a wonderful holiday symbolized by love and the giving of gifts, Christmas carols and the imagined tinkle of sleigh bells, silent snowfalls, city lights, holiday lighting displays throughout the neighborhood, the roast turkey and cranberry sauce, and of course the magical, decorated Christmas tree. But everyone knows, as well, that for all its beauty, emotion, and spiritual celebration, Christmas involves a lot of work and expense.

Consider for example, the millions of homeowners across the country who go out to their garages shortly after Thanksgiving, and begin the laborious process of unpacking boxes, untangling the strings of lights, checking them over, then breaking out the ladder and painstakingly stringing them, a few feet at a time, along the eaves or fascia boards of their house. For most of us, this part of the Christmas season is less than complete fun.

The prior art has put forth several designs for dealing with the problem of repeatedly hanging Christmas lights. Among these are:

US Patent Application No. 201610097520 to Brian Michael Dunnihoo provides a platform to house a variety of LED light displays in a rigid framework that can be permanently installed on the outside of any house or building that has a roof overhang and recessed soffit face. The panel is constructed in two parts: a bottom plate that forms the shell of the panel and houses the channels, wells and framework tor the panel, and a flat top plate that completes the enclosure of the panel. Preexisting light strings can be snapped into the bottom plate assembly and covered with the top plate to create the finished panel. Terminal connections between two or more LED light strings are made on the outside of the two adjacent panels. The panel provides a system that holds the lights in fixed position for display and a rigid framework to pivot the lights as a unit to a position substantially hidden from view and exposure from the damaging effects of wind, rain and UV sun rays.

US Patent Application No. 2010/0232151 to Andrew Douglas James provides a decorative lighting fixture assembly with end connectors to accommodate both horizontal and vertical installation. The lighting fixture assembly includes a base channel, a wiring and bulb supporting bar, and a cover unit that is configured to snap-on to the base channel and conceal the light bulbs during off-seasons.

U.S. Pat. No. 6,474,840 to Robin B. Padermos provides a device attaching to a building structure wherein decorative seasonal lighting may be installed the device having a front cover member which conceals and protects the installed seasonal lighting when the user deems it inappropriate to display such lighting, so that such installed seasonal lighting does not need to be removed from the budding structure.

None of these prior art references describe the present invention.

### SUMMARY OF THE INVENTION

It is an object of the present invention to provide a solution to the problems associated with hanging outdoor Christmas lights in the form of a pocket for enclosing outdoor Christmas lights which reduces the time and labor spent year after year by homeowners who decorate for Christmas, by stringing Christmas lights along the eaves or fascia boards of their houses.

It is a further object of the present invention to provide a pocket for outdoor lights comprising a long cover mounted to the fascia of a house, wherein the cover can be folded to form a pocket and cover the lights.

### BRIEF DESCRIPTION OF THE DRAWINGS

FIG. 1 is a front partial view illustrating an outdoor Christmas lights pocket, constructed in accordance with the present invention, showing an unfolded pocket exposing the Christmas lights and pocket mounted to the fascia of a house.

FIG. 2 is a side view illustrating the outdoor Christmas lights pocket, constructed in accordance with the present invention, showing the pocket folded hiding the Christmas lights.

FIG. 3 is a side view illustrating the pocket and light hooks of the outdoor Christmas lights pocket, constructed in accordance with the present invention.

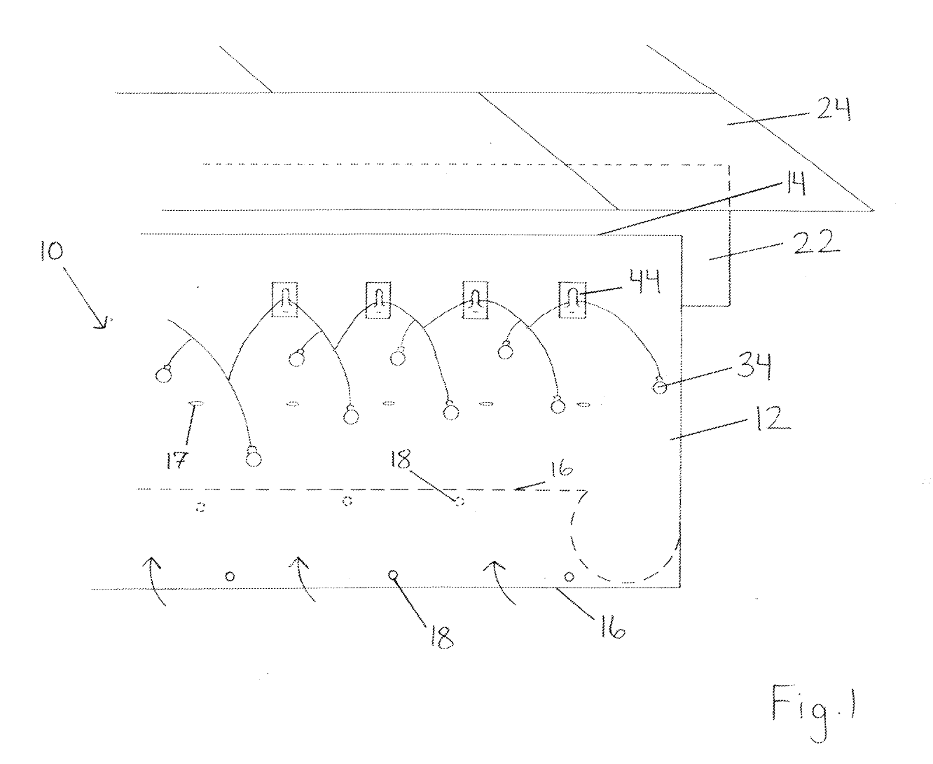

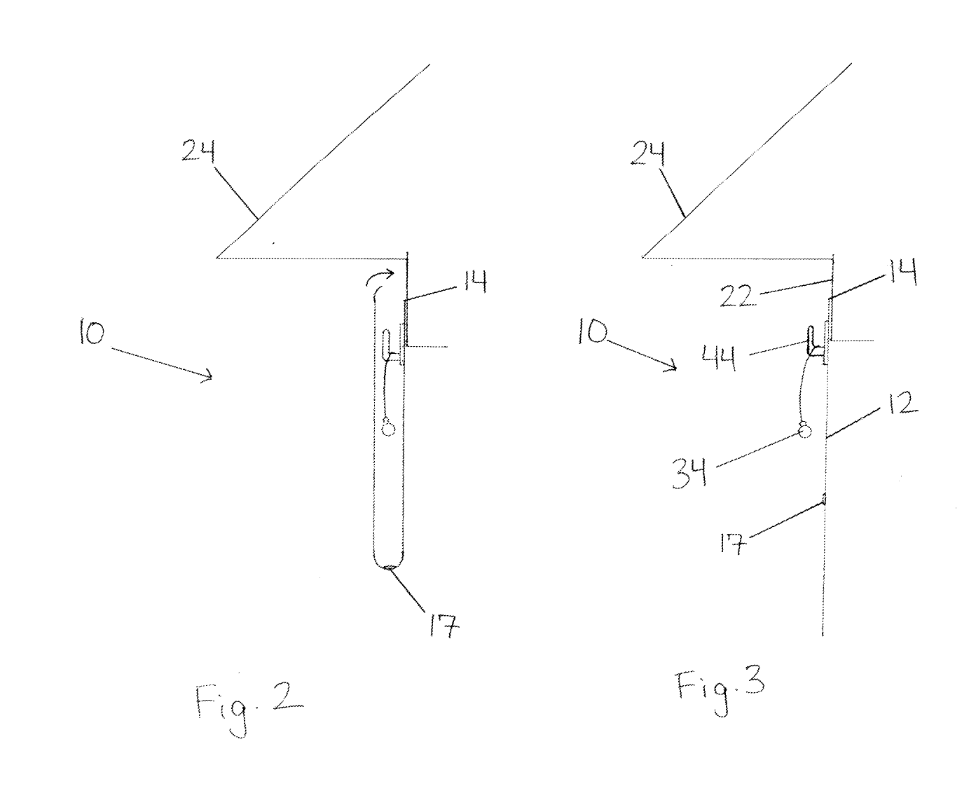

### DETAILED DESCRIPTION OF THE INVENTION

Please refer to the drawings. The Outdoor Christmas Lights Pocket 10 is a long cover 12, having a top edge 14 and a bottom edge 16, wherein the top edge 14 is mounted to the soffit or fascia boards 22 of the roof 24 of a house or other structure, by any suitable fastening means. In an embodiment, top edge 14 comprises grommeted holes for mounting on hooks 44, wherein the hooks are mounted to the fascia boards. In an alternative embodiment, top edge 14 is mounted below hooks 44, wherein the hooks are mounted to the fascia boards.

During the Christmas season and lights are on display, cover 12 hangs down behind the string of Christmas lights 34. Cover 12 can be made in any suitable color as desired. A color matching the exterior of the house is possible. At the end of the season, with the hanging light-strands and garlands still in place, the Outdoor Christmas Lights Pocket is simply folded upward to enfold, cover, and protect the lights during the rest of the year. In an embodiment, the bottom edge 16 of the Pocket 10 contains holes 18 which are grommeted and designed to fold upward and be held by hooks 44 already installed in the fascia or soffit 22, thus creating a pocket for holding the lights 34. In an alternative embodiment the top edge of the cover is held in place by hook and loop fasteners.

In an embodiment, positioned approximately mid way between top edge 14 and bottom edge 16 are drain holes 17 to allow the egress of any moisture that may develop.

The Outdoor Christmas Lights Pocket 10 can be fabricated in a canvas or synthetic polyester material like Sunbrella®, or in a polypropylene like that used for tarps. The Outdoor Christmas Lights Pocket can be produced in a variety of colors to suit user's tastes and house-painting color schemes.

Outdoor Christmas Lights Pocket are sold in sections of perhaps 6 or 12 feet each. The Outdoor Christmas Lights Pocket, in the unfolded, extended configuration, is approximately 8 inches in height. When folded or rolled upward for light storage, the Outdoor Christmas Lights Pocket is only 4 inches in depth, virtually invisible under the soffit boards of the house.

In an embodiment, a series of regularly spaced, grommet holes near the top edge 14 and bottom edge 16 are designed to hang on nails or hooks 14 established in the soffit or fascia boards 22 of the structure.

In an embodiment, the top and bottom edges of the Outdoor Christmas Lights Pocket are also finished with mating hook and loop strips mounted to the top edge and bottom edge to secure the top edge to the bottom edge, thus encasing the lights in a pocket ensuring secure closure of the pocket when it is folded upward.

In an alternative embodiment, to make it even easier for the homeowner, the pocket could be sold with lights ALREADY pre-mounted to the pocket. In this embodiment, the user would need only to hang one set of fasteners to the structure.

Use of the Outdoor Christmas Lights Pocket is simple and straightforward. The Outdoor Christmas Lights Pocket is simply hung, on fascia or soffit hooks (included in the retail package), behind the strings and garlands of Christmas lights. The Christmas lights can then stay in place all year-round, rather than being taken down and re-hung, year after year. When the holidays are over, the householder will simply take a ladder, fold or roll the Outdoor Christmas Lights Pocket upward, enveloping the lights within it, and hang the grommet holes of the Pocket's lower border to the pre-set soffit or fascia hooks. Once the hook and loop strips are mated and sealed along the upper and side edges of the Outdoor Christmas Lights Pocket, it is a sealed envelope secure against wind, moisture, and weather, and may stay in place until the next holiday season.

The Outdoor Christmas Lights Pocket offers users and households, as well as appropriate and suitable commercial establishments such as restaurants, offices, and stores, with a clean and streamlined system for displaying exterior Christmas lights; a system that will enable them to put the lights up once, and to keep the lights up year-round, concealed and protected except in the holiday season. After the Outdoor Christmas Lights Pocket has been installed, the lights can be easily displayed simply by unhooking the top border of the Pocket, and letting it fall behind the lights; and at the conclusion of the Christmas season, the Pocket and the lights are simply folded or rolled up, and re-hooked, protecting the light-strings and the underlying eaves or fascia boards from exposure to the elements. Cleverly conceived and thoughtfully designed for ease of installation and a long working life, the modular sections of the Outdoor Christmas Lights Pocket are also eminently affordable. This innovative holiday product will find a wide and enthusiastic reception in the consumer household, commercial, and institutional markets of America and the world.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. An outdoor lights pocket for storing outdoor lights comprising: a long cover having a top edge and a bottom edge, wherein the top edge is capable of being mounted to the soffit or fascia boards of the roof of a house or other structure, by any suitable fastening means, and further wherein the cover is capable of hanging behind a string of lights and the cover is further capable of being folded to form a pocket by fastening the bottom edge of the cover to the top edge of the cover.

2. The outdoor lights pocket of claim 1, wherein the cover comprises grommeted holes along the top edge of the cover for mounting on hooks, wherein the hooks are mounted to a fascia of a house.

3. The outdoor lights pocket of claim 1, wherein the cover hangs down behind the lights.

4. The outdoor lights pocket of claim 1, wherein the cover is made of a color matching the exterior of the house.

5. The outdoor lights pocket of claim 2, further comprising grommeted holes along the bottom of the cover which are capable of being folded upward and be held by hooks in the fascia.

6. The outdoor lights pocket of claim 1, wherein the top edge of the cover is held in place by hook and loop fasteners.

7. The outdoor lights pocket of claim 1, further comprising a row of drain holes positioned approximately mid way between top edge and bottom edge of the cover to allow the egress of any moisture that may develop.

8. The outdoor lights pocket of claim 1, fabricated in canvas, synthetic polyester material, or polypropylene.

9. The outdoor lights pocket of claim 2, wherein the cover further comprises grommeted holes along the bottom edge of the cover for mounting on hooks, wherein the hooks are mounted to a fascia of a house.

10. The outdoor lights pocket of claim 2, wherein the cover is produced and sold in sections of perhaps 6 or 12 feet each.

11. The outdoor lights pocket of claim 2, wherein the cover in the unfolded, extended configuration, is approximately 8 inches in height.
